(19) United States
(12) Patent Application Publication
(10) Pub. No.: US 2017/0372371 A1
(43) Pub. Date: Dec. 28, 2017

(54) MACHINE LEARNING TO MANAGE CONTACT WITH AN INACTIVE CUSTOMER TO INCREASE ACTIVITY OF THE CUSTOMER

(71) Applicant: INTERNATIONAL BUSINESS MACHINES CORPORATION, ARMONK, NY (US)

(72) Inventors: Chitra Dorai, Chappaqua, NY (US); Julian A. McIntosh, New York, NY (US); Sreeranjini R. Seetharam, Bangalore (IN); Rohit A. Shetty, Bangalore (IN)

(21) Appl. No.: 15/190,446

(22) Filed: Jun. 23, 2016

(51) Int. Cl. G06Q 30/02; G06N 99/00

(52) U.S. Cl. CPC G06Q 30/0269; G06N 99/005

(57) ABSTRACT

An approach is provided for managing a contact with an inactive customer. After grouping customers into active and inactive customers, the active customers are grouped according to activity segments corresponding to a level and style of activity. Personality traits, values, and needs of the active customers are determined. A mapping between the personality traits, values, and needs of the active customers and the activity segments is generated. Personality traits, values, and needs of an inactive customer are determined. Using the mapping and based on the personality traits, values, and needs of the inactive customer, an activity segment in which the inactive customer likely belongs is determined. Action(s) corresponding to the active customers in the determined activity segment are selected. The action(s) are applied to the inactive customer to increase a likelihood of the inactive customer becoming engaged in an activity similar to activities performed by the active customers.

### BACKGROUND

The present invention relates to machine learning, and more particularly to managing interactions with inactive customers to increase the activity of the customers.

Financial health or financial well-being is a central concern in many people's lives, especially as the result of the emergence of a significant affluent population in many countries throughout the world. Because of these financial concerns, may customers open wealth management accounts with wealth management firms that they have heard about or that they have come to trust. A wealth management account often becomes inactive (i.e., dormant) after the customer has an initial meeting with a financial advisor or makes an initial investment in financial products that are reflective of the customer's needs and risk profile. Up to 90% of investor accounts have not had any activity in the most recent one-year period.

### SUMMARY

In a first embodiment, the present invention provides a method of managing a contact with an inactive customer. The method includes receiving, by a data processing system, data specifying activity of a plurality of customers. The method further includes based on the data specifying the activity of the plurality of customers, grouping, by the data processing system, the plurality of customers into active and inactive customers. The method further includes based on data specifying activity of the active customers, grouping, by the data processing system, the active customers into defined activity segments. Each activity segment describes a corresponding level of activity and style of activity of a corresponding group of the active customers. The method further includes based on textual data authored by the active customers in the activity segments, determining, by the data processing system, personality traits, values, and needs of the active customers. The method further includes generating, by the data processing system, a mapping between (1) the personality traits, values, and needs of the active customers and (2) the defined activity segments. The method further includes based on textual data authored by an inactive customer, determining, by the data processing system, personality traits, values, and needs of the inactive customer. The method further includes based on the personality traits, values, and needs of the inactive customer, determining, by the data processing system and using the generated mapping, an activity segment in which the inactive customer likely belongs. The method further includes selecting, by the data processing system, one or more of actions corresponding to the active customers in the determined activity segment in which the inactive customer likely belongs. The method further includes applying, by the data processing system, the selected one or more actions to the inactive customer, which increases a likelihood of the inactive customer becoming engaged in an activity similar to activities performed by the active customers.

In a second embodiment, the present invention provides a computer program product including a computer-readable storage medium and a computer-readable program code stored in the computer-readable storage medium. The computer-readable program code includes instructions that are executed by a central processing unit (CPU) of a computer system to implement a method of managing a contact with an inactive customer. The method includes receiving, by the computer system, data specifying activity of a plurality of customers. The method further includes based on the data specifying the activity of the plurality of customers, grouping, by the computer system, the plurality of customers into active and inactive customers. The method further includes based on data specifying activity of the active customers, grouping, by the computer system, the active customers into defined activity segments. Each activity segment describes a corresponding level of activity and style of activity of a corresponding group of the active customers. The method further includes based on textual data authored by the active customers in the activity segments, determining, by the computer system, personality traits, values, and needs of the active customers. The method further includes generating, by the computer system, a mapping between (1) the personality traits, values, and needs of the active customers and (2) the defined activity segments. The method further includes based on textual data authored by an inactive customer, determining, by the computer system, personality traits, values, and needs of the inactive customer. The method further includes based on the personality traits, values, and needs of the inactive customer, determining, by the computer system and using the generated mapping, an activity segment in which the inactive customer likely belongs. The method further includes selecting, by the computer system, one or more of actions corresponding to the active customers in the determined activity segment in which the inactive customer likely belongs. The method further includes applying, by the computer system, the selected one or more actions to the inactive customer, which increases a likelihood of the inactive customer becoming engaged in an activity similar to activities performed by the active customers.

In a third embodiment, the present invention provides a computer system including a central processing unit (CPU); a memory coupled to the CPU; and a computer-readable storage device coupled to the CPU. The storage device includes instructions that are executed by the CPU via the memory to implement a method of managing a contact with an inactive customer. The method includes receiving, by the computer system, data specifying activity of a plurality of customers. The method further includes based on the data specifying the activity of the plurality of customers, grouping, by the computer system, the plurality of customers into active and inactive customers. The method further includes based on data specifying activity of the active customers, grouping, by the computer system, the active customers into defined activity segments. Each activity segment describes a corresponding level of activity and style of activity of a corresponding group of the active customers. The method further includes based on textual data authored by the active customers in the activity segments, determining, by the computer system, personality traits, values, and needs of the active customers. The method further includes generating, by the computer system, a mapping between (1) the personality traits, values, and needs of the active customers and (2) the defined activity segments. The method further includes based on textual data authored by an inactive customer, determining, by the computer system, personality traits, values, and needs of the inactive customer. The method further includes based on the personality traits, values, and needs of the inactive customer, determining, by the computer system and using the generated mapping, an activity segment in which the inactive customer likely belongs. The method further includes selecting, by the computer system, one or more of actions corresponding to the active customers in the determined activity segment in which the inactive customer likely belongs. The method further includes applying, by the computer system, the selected one or more actions to the inactive customer, which increases a likelihood of the inactive customer becoming engaged in an activity similar to activities performed by the active customers.

Embodiments of the present invention employs a data driven approach which uses personal attributes (i.e., personality traits, values, and needs) of inactive customers of a firm and likely activity levels and styles associated with the personal attributes to determine optimal methods of engagement, contact strategies, and product recommendations, which are personalized for the inactive customers to encourage and increase their activity, thereby increasing revenue for the firm.

### BRIEF DESCRIPTION OF THE DRAWINGS

FIG. 1 is a block diagram of a system for managing contact with an inactive customer to increase an activity of the customer, in accordance with embodiments of the present invention.

FIG. 2 is a flowchart of a process for managing a contact with an inactive customer to increase an activity of the customer, where the process is implemented in the system of FIG. 1, in accordance with embodiments of the present invention.

FIG. 3 depicts a sample view of main personality traits, categories of needs, values, and activity levels and styles, which are utilized in a generation of a mapping in the process of FIG. 2, in accordance with embodiments of the present invention.

FIG. 4 depicts a mapping example which maps main personality traits to activity levels and styles in the process of FIG. 2, in accordance with embodiments of the present invention.

FIG. 5 depicts a mapping example which maps categories of needs to activity levels and styles in the process of FIG. 2, in accordance with embodiments of the present invention.

FIG. 6 depicts a mapping example which maps values to activity levels and styles in the process of FIG. 2, in accordance with embodiments of the present invention.

FIG. 7 is a block diagram of a computer that is included in the system of FIG. 1 and that implements the process of FIG. 2, in accordance with embodiments of the present invention.

### DETAILED DESCRIPTION

### Overview

Embodiments of the present invention recognize that inactive or dormant customer accounts presents unique challenges to firms that want to increase their revenue by increasing revenue-related activities of their customers. Wealth management firms face a unique challenge in attempting to realize value from inactive (i.e., dormant) accounts. Encouraging and increasing activity from inactive accounts may lead to a significant revenue growth if the inactive investors can be persuaded to be more engaged, be more diligent in tracking the performance of their holdings, and perform more transactions to improve returns from their investments. Using existing marketing tactics has failed to engage dormant customers.

Embodiments of the present invention provide a data-driven deeper understanding of dormant accounts by determining inactive customers' personality traits, needs, and values, which lead to improved actionable insights about the inactive customers to provide a tailored approach to increase their engagement and activity. Embodiments of the present invention determine relationships between personality traits, needs, and values of the active customers and activity levels and styles of active customers, and use those relationships to determine likely activity levels and styles associated with the personality traits, needs, and values of inactive customers. Based on the likely activity levels and styles of the inactive customers, a wealth management firm (or another type of firm) can engage, offer, and consult with inactive customers at just the right time to make the customers more active and transactional. The approach based on the actionable insights may include providing an experience that a customer had been lacking, a customized promotional campaign for a product, or a product that is tailored to the customer.

For example, if an inactive customer of a wealth management firm resembles an active customer who acts upon reminders from the firm, then embodiments of the present invention select an action of contacting the inactive customer on a regular basis to review the account and determine what help is needed, thereby increasing activity of the inactive customer.

System for Managing a Contact with an Inactive Customer

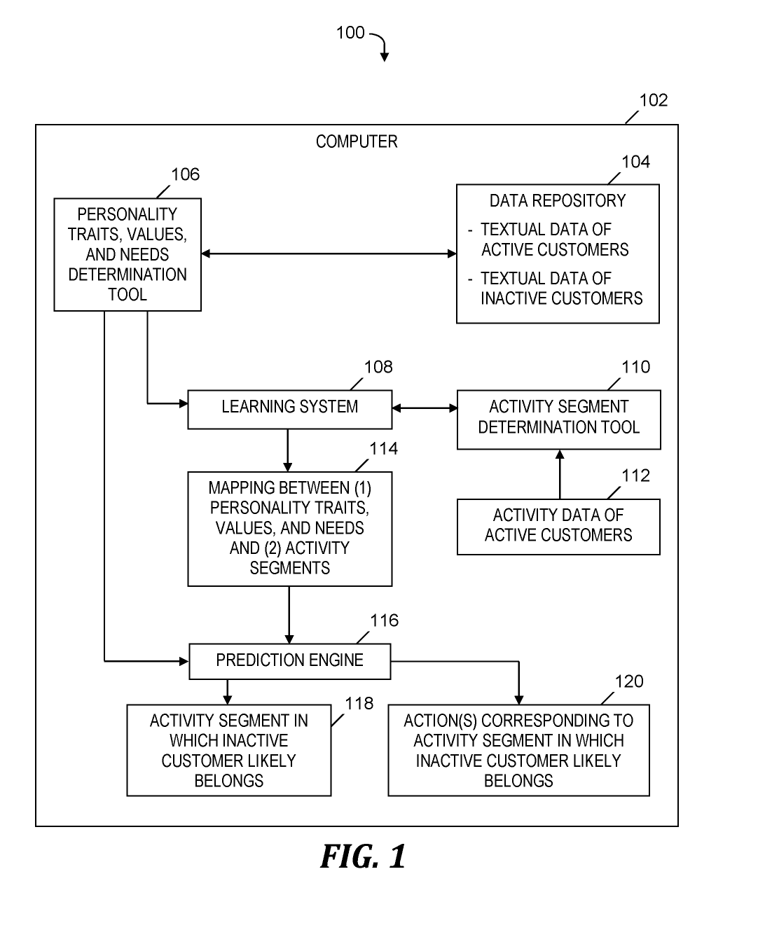

FIG. 1 is a block diagram of a system 100 for managing contact with an inactive customer to increase an activity of the customer, in accordance with embodiments of the present invention. System 100 includes a computer 102, which includes a data repository 104 and executes a software-based personality traits, values, and needs determination tool 106, a software-based learning system 108, and a software-based activity segment determination tool 110. Data repository 104 stores identifications of customers who are active customers and identifications of other customers who are inactive customers. Data repository 104 also stores textual data authored by the active customers and textual data authored by the inactive customers. In one embodiment, data repository 104 stores data specifying activity of customers.

Personality traits, values, and needs determination tool 106 determines (1) personality traits, values, and needs of the active customers based on the textual data authored by the active customers and (2) personality traits, values, and needs of the inactive customers based on the textual data authored by the inactive customers . Activity segment determination tool 110 determines activity segments of respective active customers based on activity data 112 of the active customers (i.e., data specifying activity of the active customers, such as the frequency and density of transactions). In one embodiment, activity data 112 is stored in data repository 104. Computer 102 executes software (not shown) that determines contact strategies or other actions that are effective in eliciting behavior of active customers, where the behavior is desired by a business that is utilizing system 100, and where the contact strategies or other actions are determined to be associated with respective activity segments of the active customers. The behavior that is elicited by the contact strategies or other actions indicates the active customers are engaged in activities desired by the business, such as purchasing a product or completing a transaction.

Learning system 108 generates a mapping 114 between the personality traits, values, and needs of the active customers and the activity segments of the active customers. Computer 102 also executes a software-based prediction engine 116 which, based on personality traits, values, and needs of an inactive customer and using mapping 114, determines an activity segment 118 in which the inactive customer likely belongs. The determined activity segment 118 is one of the activity segments that had been determined by the activity segment determination tool 110. Prediction engine 116 determines action(s) 120 (e.g., contact strategies) corresponding to the activity segment in which the inactive customer likely belongs and applies the action(s) to the inactive customer, which increases a likelihood that the inactive customer becomes engaged in an activity similar to at least one of the activities performed by the active customers (increase the number of transactions completed by the inactive customer in a specified time period or increase the number or value of purchases of products by the inactive customer).

In one embodiment, computer 102 executes a software-based customer contact management system (not shown) which includes personality, traits, values, and needs determination tool 106, learning system 108, activity segment determination tool 110, and prediction engine 116.

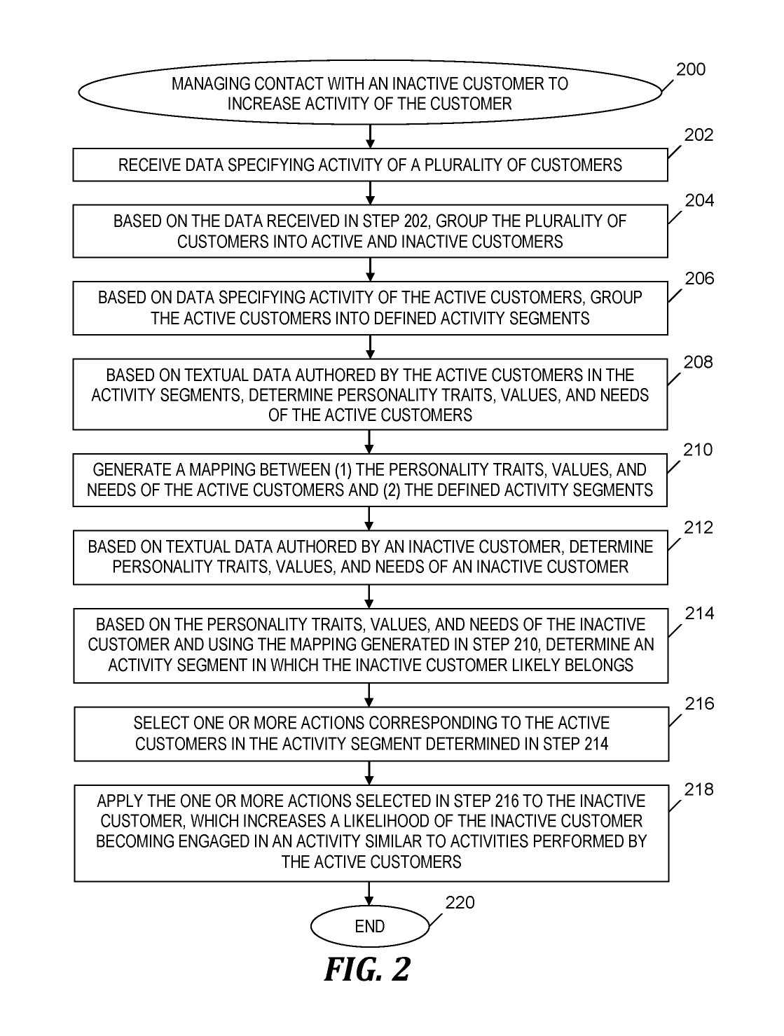

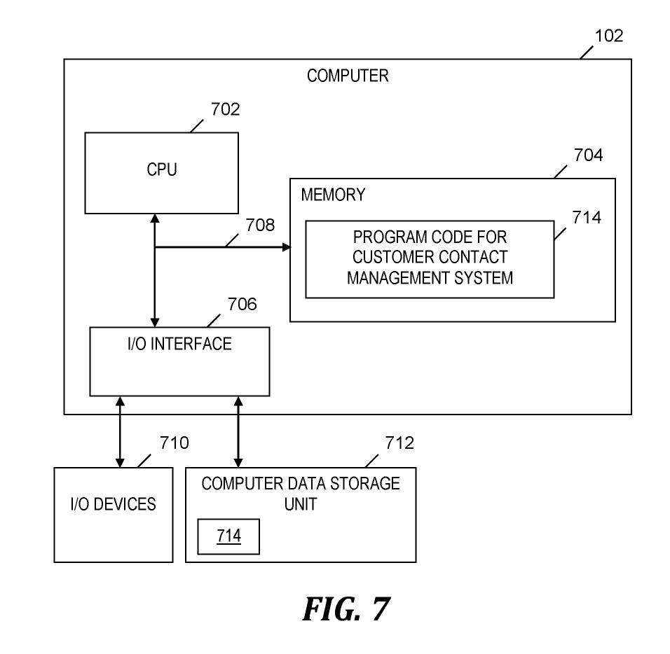

The functionality of the components shown in FIG. 1 is described in more detail in the discussion of FIG. 2 and FIG. 7 presented below.

Process for Managing a Contact with an Inactive Customer

FIG. 2 is a flowchart of a process for managing a contact with an inactive customer to increase an activity of the customer, where the process is implemented in the system of FIG. 1, in accordance with embodiments of the present invention. The process of FIG. 2 starts at step 200. In step 202, computer system 102 (see FIG. 1) executes software (not shown in FIG. 1) that receives data specifying activity of a plurality of customers. In step 204, computer system 102 (see FIG. 1) executes software (not shown in FIG. 1) that, based on the data received in step 202, groups the plurality of customers into active customers and inactive customers and stores the identifications of the active and inactive customers in data repository 104 (see FIG. 1).

In one embodiment, in step 204, computer system 102 (see FIG. 1) executes software (not shown in FIG. 1) that (1) receives a period of time which is based on a policy of the business that employs system 100 (see FIG. 1); (2) determines transactional activities of the plurality of customers over the received period of time; (3) identifies one group of customers included in the plurality of customers who each performed at least a predetermined number of the transactional activities during the received period of time and identifies another group of customers included in the plurality of customers who each performed less than the predetermined number of the transactional activities during the period of time; (4) based on the identified one group of customers each performing at least the predetermined number of transactional activities during the received period of time, categorizes the one group of customers as the active customers; and (5) based on the identified other group of customers each performing less than the predetermined number of transactional activities during the received period of time, categorizes the other group of customers as the inactive customers.

In step 206, based on data specifying activity of the active customers (i.e., activity data 112 (see FIG. 1)), activity segment determination tool 110 (see FIG. 1) groups the active customers into defined activity segments. In one embodiment, activity data 112 (see FIG. 1) includes transaction data such as frequency and/or density of transactions. In one embodiment, each activity segment identifies a corresponding level of activity (i.e., activity level) (e.g., high and low, or high, low-high, low-medium, and low-low) and a corresponding style of activity (i.e., activity style) (e.g., day trader-like investor, reactive investor, steady investor, and an investor who acts upon reminders).

In one embodiment, step 206 includes activity segment determination tool 110 (see FIG. 1) determining for each active customer a corresponding activity score. The activity score for a customer is a function of a sum of weighted measurements of transactional behavior attributes of the customer, which includes a total number of transactions, recency of the transactions, the monetary value of the transactions (i.e., transaction size), transaction frequency, and transaction density. One example of a formula for an activity score is:

Activity score=w1*total number of transactions to date+w2*days past since most recent transaction+w3*average monetary value of transactions to date+w4*average monthly transactional rate+w5*average inter-transactional distance in a month,

where w1, w2, w3, w4, and w5 are the weighting factors.

In one embodiment, the activity score of a customer uses historical transaction data from a time period of n years preceding the date of the most recent transaction of the customer included in activity data 112 (see FIG. 1), where n is user-configurable. As one example, the activity score uses historical data from a two-year time period preceding the date of the most recent transaction (i.e., n=2).

Based on the activity scores of the active customers, activity segment determination tool 110 (see FIG. 1) places the active customers in tranches or groups. As one example, activity segment determination tool 110 (see FIG. 1) segments the active customers based on the level of activity such as a high activity group and a low activity group. Since an understanding of low levels of activity is important for the management of contacts with inactive customers provided by system 100 (see FIG. 1), the low activity group can be further segmented to increase granularity. For instance, the low activity group can be further segmented into three sub-groups in order of activity from most to least active: low-high, low-medium, and low-low.

Activity segment determination tool 110 (see FIG. 1) may segment customers based on the customers' style of activity (or a combination of level of activity and style of activity). For example, if the activity includes wealth management transactions, the customers may be segmented into day trader-like, steady investors, reactive investors (i.e., make frequent transactions, but no steadiness), sporadic investors, etc.

In one embodiment, step 206 includes activity segment determination tool 110 (see FIG. 1) segments the active customers into defined activity segments by using a k-nearest neighbor technique.

Prior to step 208, personality traits, values, and needs determination tool 106 (see FIG. 1) retrieves from data repository 104 (see FIG. 1) textual data authored by the active customers grouped in step 204. The textual data may include social media entries authored by the active customers. In step 208, based on the retrieved textual data authored by the active customers, personality traits, values, and needs determination tool 106 (see FIG. 1) determines personality traits, values, and needs of the active customers grouped in step 204. In one embodiment, personality traits, values, and needs determination tool 106 (see FIG. 1) is the Personality Insights service offered by International Business Machines Corporation located in Armonk, N.Y.

In one embodiment, step 208 includes personality traits, values, and needs determination tool 106 (see FIG. 1) determining the personality traits, values, and needs of the active customers based on a cognitive system analyzing (1) text selected from social media entries provided and authored by the active customers and (2) data about interactions that specify the active customers. The data about interactions may include data about web registration, website visits, customer service contacts, and preferences of channel of contact.

In step 210, learning system 108 (see FIG. 1) generates the mapping 114 (see FIG. 1) between (1) the personality traits, values, and needs determined in step 208 (i.e., the personality traits, values, and needs of the active customers) and (2) the defined activity segments into which the active customers were grouped in step 206 (i.e., the activity segments of the active customers).

In one embodiment, step 210 includes learning system 108 (see FIG. 1) receiving data specifying personality traits, values, and needs of a group of people, where the received data includes (1) multiple character features and (2) multiple activity segments which are associated with the multiple character features. After receiving the aforementioned data specifying personality traits, values, and needs, learning system 108 (see FIG. 1) builds a model which learns associations between the multiple character features and the multiple activity segments. Learning system 108 (see FIG. 1) uses the aforementioned model to map one or more of the character features to respective one or more of the activity segments. In one embodiment, learning system 108 (see FIG. 1) builds the aforementioned model by determining associations between (1) the personality traits, values, and needs of the active customers and (2) the defined activity segments by using (i) a classification technique that employs decision trees or (ii) a parametric machine learning algorithm that employs regression or an ensemble model.

Prior to step 212, personality traits, values, and needs determination tool 106 (see FIG. 1) retrieves from data repository 104 (see FIG. 1) textual data authored by an inactive customer (i.e., one of the inactive customers grouped in step 204). The textual data may include social media entries authored by the inactive customer. In step 212, based on the retrieved textual data authored by the inactive customers, personality traits, values, and needs determination tool 106 (see FIG. 1) determines personality traits, values, and needs of the inactive customer.

In one embodiment, step 212 includes personality traits, values, and needs determination tool 106 (see FIG. 1) determining the personality traits, values, and needs of the inactive customers based on a cognitive system analyzing (1) text selected from social media entries provided and authored by the inactive customers and (2) data about interactions that specify the inactive customers. The data about interactions may include data about web registration, website visits, customer service contacts, and preferences of channel of contact.

In step 214, based on the personality traits, values, and needs determined in step 212 (i.e., the personality traits, values, and needs of the inactive customers) and using the mapping 114 (see FIG. 1) generated in step 210, prediction engine 116 (see FIG. 1) determines an activity segment in which the inactive customer likely belongs (i.e., determines activity segment 118 (see FIG. 1), which is one of the defined activity segments into which the active customers are grouped in step 206).

In step 216, prediction engine 116 (see FIG. 1) selects one or more actions corresponding to the active customers in the activity segment determined in step 214. In one embodiment, the one or more actions include a contact strategy which specifies a manner (i.e., channel) of contact, content of a contact (e.g., a promotion to encourage buying a particular product or service), or both a manner of contact and the content of the contact which helps maintain the corresponding active customers' regular engagement in activities such as completing investment transactions or making purchases. The channel of contact may be, for example, contact via the web, telephone, email, or face-to-face.

Prediction engine 116 (see FIG. 1) selects the one or more actions in step 216 based on a recognition that the inactive customer most likely will behave in a manner similar to active customers that belong to the same activity segment that was determined in step 214 as the activity segment in which the inactive customer likely belongs. Based on this recognition, insights about how the active customers respond to particular contact strategies help determine the one or more actions which, when applied to the inactive customer, will increase a likelihood that the inactive customer will become active (e.g., increase the rate of completed wealth management transactions by the inactive customer).

In one embodiment, step 216 includes prediction engine 116 (see FIG. 1) (1) selecting a preferred contact method or channel by which the active customers are staying in contact with an enterprise that employs system 100 (see FIG. 1), and which corresponds to the activity segment determined in step 214 (i.e., the activity segment in which the inactive customer likely belongs); and (2) contacting the inactive customer by a contact that uses the selected contact method or channel, thereby increasing a likelihood that the inactive customer responds to the contact and becomes an active customer.

In another embodiment, step 216 includes prediction engine 116 (see FIG. 1) (1) determining products in which the active customers are likely to be interested (e.g., interested in purchasing), where each product corresponds to one of the defined activity segments; and (2) recommending one of the products to the inactive customer so that the recommended product has a corresponding activity segment which matches the activity segment determined in step 214, thereby increasing a likelihood that the inactive customer buys the recommended product and becomes an active customer.

In step 218, prediction engine 116 (see FIG. 1) applies the one or more actions selected in step 216 to the inactive customer, which increases a likelihood that the inactive customer becomes engaged (or increases engagement) in an activity which is similar to activities regularly performed by the active customers. For example, prediction engine 116 (see FIG. 1) contacts the inactive customer by using a contact strategy selected in step 216, which causes the inactive customer to increase a rate of completing investment transactions or purchases per unit of time.

The process of FIG. 2 ends at step 220.

### Learning System

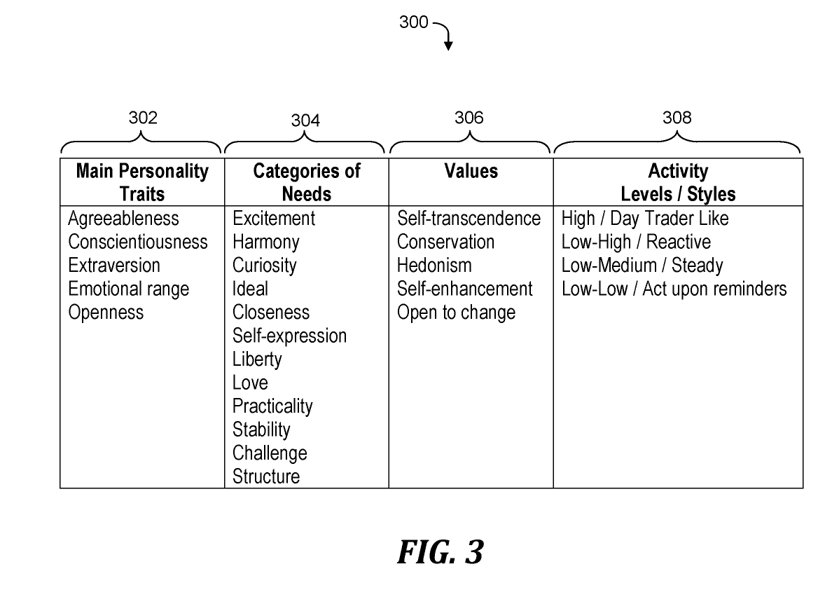

FIG. 3 depicts a sample view 300 of main personality traits 302, categories of needs 304, values 306, and activity levels and styles 308, which are utilized in a generation of the mapping 114 (see FIG. 1) in the process of FIG. 2, in accordance with embodiments of the present invention. View 300 includes main personality traits 302, categories of needs 304, and values 306, which are mapped by learning system 108 (see FIG. 1) to activity levels and styles 308 in step 210 (see FIG. 2) using classification techniques such as decision trees or a parametric machine learning algorithm (e.g., regression). In one embodiment, learning system 108 (see FIG. 1) generates mapping 114 (see FIG. 1) to include a mapping from sub-traits (not shown) categorized under each of the main personality traits 302 to activity levels and styles 308.

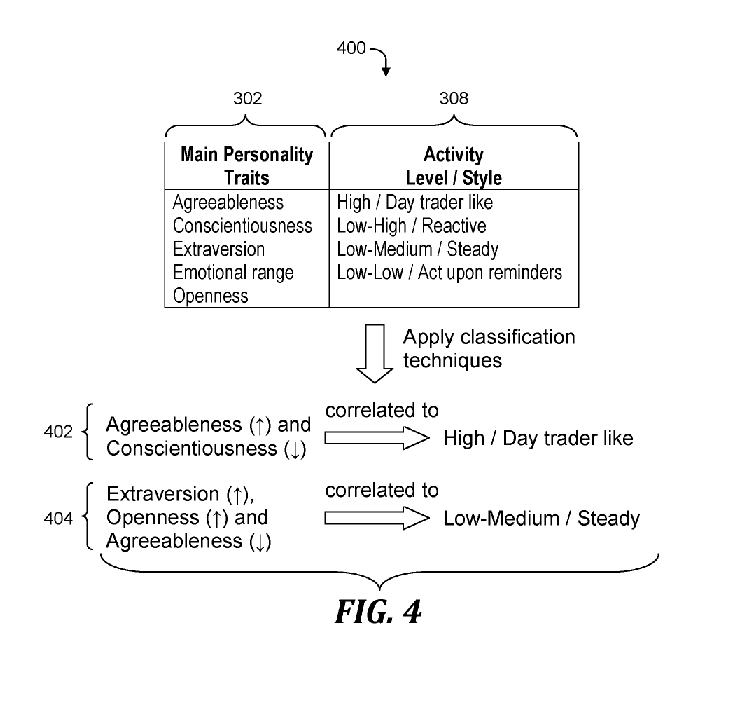

FIG. 4 depicts a mapping example 400 which maps main personality traits 302 mapped to activity levels and styles 308 in the process of FIG. 2, in accordance with embodiments of the present invention. Learning system 108 (see FIG. 1) applies classification techniques to generate mapping example 400 which includes a correlation 402 of a combination of a high level of the main personality trait of agreeableness and a low level of the main personality trait of conscientiousness to a combination of a high investment activity level and a day trader-like investment activity style. Mapping example 400 also includes a correlation 404 of a combination of high levels of the main personality traits of extraversion and openness and a low level of the main personality trait of agreeableness to a combination of a low-medium level of investment activity and a steady investment activity style.

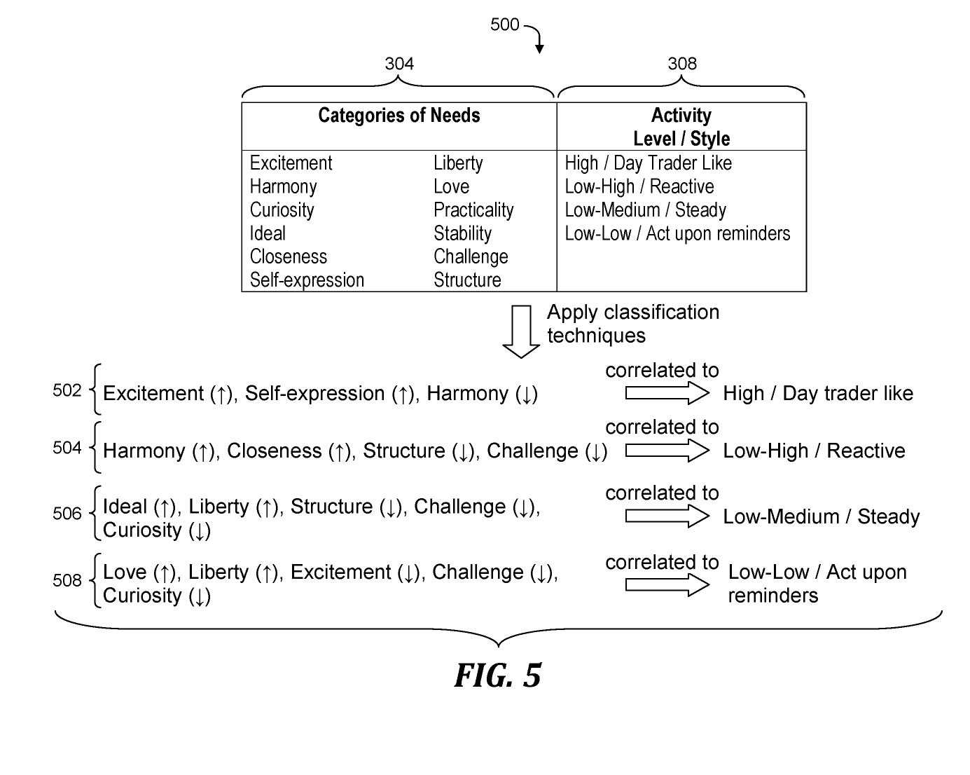

FIG. 5 depicts a mapping example 500 which maps categories of needs 304 to activity levels and styles 308 in the process of FIG. 2, in accordance with embodiments of the present invention. Learning system 108 (see FIG. 1) applies classification techniques to generate mapping example 500 which includes a correlation 502 of a combination of a high level of the needs categories of excitement and self-expression and a low level of the needs category of harmony to a combination of a high investment activity level and a day trader-like investment activity style. Mapping example 500 includes a correlation 504 of a combination of high levels of the needs categories of harmony and closeness and low levels of the needs categories of structure and challenge to a combination of a low-high level of investment activity and a reactive investment activity style.

Mapping example 500 includes a correlation 506 of a combination of high levels of the needs categories of ideal and liberty and low levels of the needs categories of structure, challenge, and curiosity to a combination of a low-medium investment activity level and a steady investment activity style. Mapping example 500 also includes a correlation 508 of a combination of high levels of the needs categories of love and liberty and low levels of the needs categories of excitement, challenge, and curiosity to a combination of a low-low level of investment activity and an “act upon reminders” investment activity style by which a customer is more likely to make investment transactions or purchase products in response to receiving reminders.

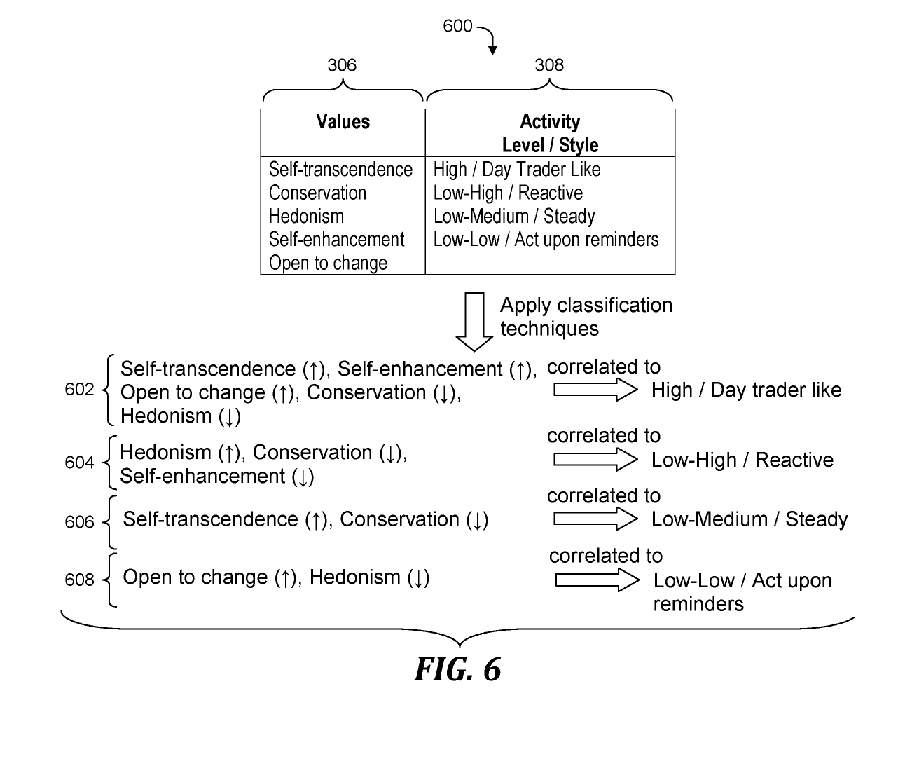

FIG. 6 depicts a mapping example 600 which maps values 306 to activity levels and styles 308 in the process of FIG. 2, in accordance with embodiments of the present invention. Learning system 108 (see FIG. 1) applies classification techniques to generate mapping example 600 which includes a correlation 602 of a combination of high levels of the values of self-transcendence, self-enhancement, and open to change and low levels of the values of conservation and hedonism to a combination of a high investment activity level and a day trader-like investment activity style. Mapping example 600 includes a correlation 604 of a combination of a high level of the value of hedonism and low levels of the values of conservation and self-enhancement to a combination of a low-high level of investment activity and a reactive investment activity style.

Mapping example 600 includes a correlation 606 of a combination of a high level of the value of self-transcendence and a low level of the value of conservation to a combination of a low-medium level of investment activity and a steady investment activity style. Mapping example 600 also includes a correlation 608 of a combination of a high level of the value of “open to change” and a low level of the value of hedonism to a combination of a low-low level of investment activity and an “act upon reminders” investment activity style.

### EXAMPLES

As one example, prediction engine 116 (see FIG. 1) determines the inactive customer to likely belong to a low-high activity segment in step 214 (see FIG. 2). Mapping 114 (see FIG. 1) associates a high level of the value of hedonism with the low-high activity segment. An action selected in step 216 (see FIG. 2) to build the inactive customer's confidence is part of an action plan which leverages the tech savvy and trendy nature of customers who have a high level of hedonism by channeling these customers with relevant market news alerts to their cell phones or to their email box depending on their preferred choice of contact channel, which is identified from a stated channel preference/channel optimization model.

Furthermore, because customers who have a high level of hedonism are adventurous and risk-takers, the action plan includes a wealth management firm devising tailored investment plans wherein each of their portfolios include mostly stocks that yield a high return on equity. These stocks are identified by market research report analysis. The performance of this action plan may be tested by conducting A/B testing on Test (i.e., solicited) and Control (i.e., unsolicited) groups of the customers who belong to the low-high activity segment.

As another example, prediction engine 116 (see FIG. 1) determines the inactive customer to likely belong to a low-medium activity segment in step 214 (see FIG. 2). Mapping 114 (see FIG. 1) associates a high level of the value of self-transcendence with the low-medium activity segment. An action selected in step 216 (see FIG. 2) to engage the inactive customer is part of an action plan which leverages the traditionalist and altruistic nature of customers who have a high level of self-transcendence. As these customers are self-transcendent by nature, a wealth management firm should advise these customers to invest in Social Impact Bonds. Further, these customers should be contacted by a wealth management firm via a direct mailer channel to share their investment performance summary. The direct mailer channel is identified from the stated channel preference/channel optimization model. The most likely responders to this action plan can be identified by developing a Response Model. The performance of this action plan can be tested by conducting AB testing on Test (i.e., solicited) and Control (i.e., unsolicited) groups of customers in the low-medium activity segment.

As still another example, prediction engine 116 (see FIG. 1) determines the inactive customer to likely belong to a low-low activity segment in step 214 (see FIG. 2). Mapping 114 (see FIG. 1) associates a high level of the value of “open to change” with the low-low activity segment. An action selected in step 216 (see FIG. 2) to engage the inactive customer is part of an action plan which leverages the liberal, experimental, free-thinking, and flexible nature of customers who have a high level of the “open to change” value. As these customers are flexible and experimental, a wealth management firm should recommend stocks that come out as significant in a Market Basket Analysis conducted on investment portfolio stocks of active customers having “open to change” as their dominant value. The action plan includes conveying market related information to these customers via mobile alerts. The performance of this action plan can be tested by conducting A/B testing on Test (i.e., solicited) and Control (i.e., unsolicited) groups of customers in the low-low activity segment.

### Computer System

FIG. 7 is a block diagram of a computer that is included in the system of FIG. 1 and that implements the process of FIG. 2, in accordance with embodiments of the present invention. Computer 102 is a computer system that generally includes a central processing unit (CPU) 702, a memory 704, an input/output (I/O) interface 706, and a bus 708. Computer 102 is coupled to I/O devices 710 and a computer data storage unit 712. CPU 702 performs computation and control functions of computer 102, including executing instructions included in program code 714 for a customer contact management system which includes personality, traits, values, and needs determination tool 106 (see FIG. 1), learning system 108 (see FIG. 1), activity segment determination tool 110 (see FIG. 1), and prediction engine 116 (see FIG. 1) to perform a method of managing a contact with an inactive customer to increase activity of the customer, where the instructions are executed by CPU 702 via memory 704. CPU 702 may include a single processing unit, or be distributed across one or more processing units in one or more locations (e.g., on a client and server).

Memory 704 includes a known computer readable storage medium, which is described below. In one embodiment, cache memory elements of memory 704 provide temporary storage of at least some program code (e.g., program code 714) in order to reduce the number of times code must be retrieved from bulk storage while instructions of the program code are executed. Moreover, similar to CPU 702, memory 704 may reside at a single physical location, including one or more types of data storage, or be distributed across a plurality of physical systems in various forms. Further, memory 704 can include data distributed across, for example, a local area network (LAN) or a wide area network (WAN).

I/O interface 706 includes any system for exchanging information to or from an external source. I/O devices 710 include any known type of external device, including a display device, keyboard, etc. Bus 708 provides a communication link between each of the components in computer 102, and may include any type of transmission link, including electrical, optical, wireless, etc.

I/O interface 706 also allows computer 102 to store information (e.g., data or program instructions such as program code 714) on and retrieve the information from computer data storage unit 712 or another computer data storage unit (not shown). Computer data storage unit 712 includes a known computer-readable storage medium, which is described below. In one embodiment, computer data storage unit 712 is a non-volatile data storage device, such as a magnetic disk drive (i.e., hard disk drive) or an optical disc drive (e.g., a CD-ROM drive which receives a CD-ROM disk).

Memory 704 and/or storage unit 712 may store computer program code 714 that includes instructions that are executed by CPU 702 via memory 704 to manage a contact with an inactive customer to increase activity of the customer. Although FIG. 7 depicts memory 704 as including program code 714, the present invention contemplates embodiments in which memory 704 does not include all of code 714 simultaneously, but instead at one time includes only a portion of code 714.

Further, memory 704 may include an operating system (not shown) and may include other systems not shown in FIG. 7.

Storage unit 712 may include data repository 104 (see FIG. 1) and may store any combination of identifiers of active customers, identifiers of inactive customers, text authored by active customers, text authored by inactive customers, and activity data of active customers 112 (see FIG. 1).

As will be appreciated by one skilled in the art, in a first embodiment, the present invention may be a method; in a second embodiment, the present invention may be a system; and in a third embodiment, the present invention may be a computer program product.

Any of the components of an embodiment of the present invention can be deployed, managed, serviced, etc. by a service provider that offers to deploy or integrate computing infrastructure with respect to managing a contact with an inactive customer to increase activity of the customer. Thus, an embodiment of the present invention discloses a process for supporting computer infrastructure, where the process includes providing at least one support service for at least one of integrating, hosting, maintaining and deploying computer-readable code (e.g., program code 714) in a computer system (e.g., computer 102) including one or more processors (e.g., CPU 702), wherein the processor(s) carry out instructions contained in the code causing the computer system to manage a contact with an inactive customer to increase activity of the customer. Another embodiment discloses a process for supporting computer infrastructure, where the process includes integrating computer-readable program code into a computer system including a processor. The step of integrating includes storing the program code in a computer-readable storage device of the computer system through use of the processor. The program code, upon being executed by the processor, implements a method of managing a contact with an inactive customer to increase activity of the customer.

While it is understood that program code 714 for managing a contact with an inactive customer to increase activity of the customer may be deployed by manually loading directly in client, server and proxy computers (not shown) via loading a computer-readable storage medium (e.g., computer data storage unit 712), program code 714 may also be automatically or semi-automatically deployed into computer 102 by sending program code 714 to a central server or a group of central servers. Program code 714 is then downloaded into client computers (e.g., computer 102) that will execute program code 714. Alternatively, program code 714 is sent directly to the client computer via e-mail. Program code 714 is then either detached to a directory on the client computer or loaded into a directory on the client computer by a button on the e-mail that executes a program that detaches program code 714 into a directory. Another alternative is to send program code 714 directly to a directory on the client computer hard drive. In a case in which there are proxy servers, the process selects the proxy server code, determines on which computers to place the proxy servers' code, transmits the proxy server code, and then installs the proxy server code on the proxy computer. Program code 714 is transmitted to the proxy server and then it is stored on the proxy server.

Another embodiment of the invention provides a method that performs the process steps on a subscription, advertising and/or fee basis. That is, a service provider, such as a Solution Integrator, can offer to create, maintain, support, etc. a process of managing a contact with an inactive customer to increase activity of the customer. In this case, the service provider can create, maintain, support, etc. a computer infrastructure that performs the process steps for one or more customers. In return, the service provider can receive payment from the customer(s) under a subscription and/or fee agreement, and/or the service provider can receive payment from the sale of advertising content to one or more third parties.

The present invention may be a system, a method, and/or a computer program product. The computer program product may include a computer readable storage medium (or media) (memory 704 and computer data storage unit 712) having computer readable program instructions 714 thereon for causing a processor (e.g., CPU 702) to carry out aspects of the present invention.

The computer readable storage medium can be a tangible device that can retain and store instructions (e.g., program code 714) for use by an instruction execution device (e.g., computer 102). The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions (e.g., program code 714) described herein can be downloaded to respective computing/processing devices (e.g., computer 102) from a computer readable storage medium or to an external computer or external storage device (e.g., computer data storage unit 712) via a network (not shown), for example, the Internet, a local area network, a wide area network and/or a wireless network. The network may comprise copper transmission cables, optical transmission fibers, wireless transmission, routers, firewalls, switches, gateway computers and/or edge servers. A network adapter card (not shown) or network interface (not shown) in each computing/processing device receives computer readable program instructions from the network and forwards the computer readable program instructions for storage in a computer readable storage medium within the respective computing/processing device.

Computer readable program instructions (e.g., program code 714) for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages, as well as languages supporting data analytics, such as R, SPSS scripting, etc. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations (e.g., FIG. 2) and/or block diagrams (e.g., FIG. 1 and FIG. 7) of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions (e.g., program code 714).

These computer readable program instructions may be provided to a processor (e.g., CPU 702) of a general purpose computer, special purpose computer, or other programmable data processing apparatus (e.g., computer 102) to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium (e.g., computer data storage unit 712) that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions (e.g., program code 714) may also be loaded onto a computer (e.g. computer 102), other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While embodiments of the present invention have been described herein for purposes of illustration, many modifications and changes will become apparent to those skilled in the art. Accordingly, the appended claims are intended to encompass all such modifications and changes as fall within the true spirit and scope of this invention.

What is claimed is:

1. A method of managing a contact with an inactive customer, the method comprising the steps of:
receiving, by a data processing system, data specifying activity of a plurality of customers and based on the data specifying the activity of the plurality of customers, grouping the plurality of customers into active and inactive customers;
based on data specifying activity of the active customers, grouping, by the data processing system, the active customers into defined activity segments, each activity segment describing a corresponding level of activity and style of activity of a corresponding group of the active customers;
based on textual data authored by the active customers in the activity segments, determining, by the data processing system, personality traits, values, and needs of the active customers;
generating, by the data processing system, a mapping between (1) the personality traits, values, and needs of the active customers and (2) the defined activity segments;
based on textual data authored by an inactive customer, determining, by the data processing system, personality traits, values, and needs of the inactive customer;
based on the personality traits, values, and needs of the inactive customer, determining, by the data processing system and using the generated mapping, an activity segment in which the inactive customer likely belongs;
selecting, by the data processing system, one or more actions corresponding to the active customers in the determined activity segment in which the inactive customer likely belongs; and
applying, by the data processing system, the selected one or more actions to the inactive customer, which increases a likelihood of the inactive customer becoming engaged in an activity similar to activities performed by the active customers.

2. The method of claim 1, wherein the step of generating the mapping includes the steps of:
receiving, by the data processing system, personality traits, values and needs data of a group of people, the received personality traits, values and needs data including a multitude of character features and a multitude of activity segments which are associated with the multitude of character features;
building, by the data processing system, a model which learns associations between the multitude of character features and the multitude of activity segments; and
mapping, by the data processing system and using the model, one or more of the multitude of character features to one or more of the multitude of activity segments.

3. The method of claim 2, wherein the step of building the model includes the step of determining associations between the personality traits, values, and needs of the active customers and the defined activity segments by using a classification technique that employs decision trees or a parametric machine learning algorithm that employs regression.

4. The method of claim 1, wherein the step of selecting the one or more actions corresponding to the active customers in the determined activity segment in which the inactive customer likely belongs includes the steps of:
selecting, by the data processing system, a preferred contact method or channel by which the active customers are staying in contact with an enterprise, and which corresponds to the determined activity segment in which the inactive customer likely belongs; and
contacting the inactive customer using the selected contact method or channel, thereby increasing a likelihood that the inactive customer responds to the contact and becomes an active customer.

5. The method of claim 1, wherein the step of selecting the one or more actions corresponding to the active customers in the determined activity segment in which the inactive customer likely belongs includes the steps of:
determining, by the data processing system, products in which the active customers are likely to be interested, each product corresponding to one of the activity segments; and
recommending one of the products to the inactive customer so that the recommended product has a corresponding activity segment which matches the determined activity segment in which the inactive customer likely belongs, thereby increasing a likelihood that the inactive customer buys the recommended product and becomes an active customer.

6. The method of claim 1, wherein the step of grouping the plurality of customers includes the steps of:
receiving a period of time which is based on a company policy;
determining transactional activities of the plurality of customers over the period of time;
identifying one group of customers included in the plurality of customers who each performed at least a predetermined number of the transactional activities during the period of time and identifying another group of customers included in the plurality of customers who each performed less than the predetermined number of the transactional activities during the period of time;
based on the identified one group of customers each performing at least the predetermined number of transactional activities during the period of time, categorizing the one group of customers as the active customers; and
based on the identified other group of customers each performing less than the predetermined number of transactional activities during the period of time, categorizing the other group of customers as the inactive customers.

7. The method of claim 1, further comprising the steps of:
based on the data specifying the activity of the active customers, determining, by the data processing system, activity scores for the active customers;
based on the activity scores, determining, by the data processing system, levels of activity and styles of activity of the active customers; and
determining, by the data processing system, the activity segments based on the activity scores.

8. The method of claim 7, further comprising the steps of:
determining, by the data processing system, an activity score of an active customer; and
based on the activity score, determining, by the data processing system, an activity segment in which the active customer belongs, wherein the activity score includes a sum of a first weight multiplied by a total number of transactions performed by the active customer in a predetermined time period, a second weight multiplied by an amount of time since a most recent transaction of the transactions performed by the active customer in the predetermined time period, a third weight multiplied by an average monetary value of the transactions performed by the active customer in the predetermined time period, a fourth weight multiplied by an average monthly transactional rate of the transactions performed by the active customer in the predetermined time period, and a fifth weight multiplied by an average monthly inter-transactional distance of the transactions performed by the active customer in the predetermined time period.

9. The method of claim 1, wherein the step of determining the personality traits, values, and needs of the active customers is based on a cognitive system analyzing (1) text selected from social media entries provided by the active customers and (2) data about interactions that specify the active customers, and wherein the step of determining the personality traits, values, and needs of the inactive customers is based on the cognitive system analyzing (1) text selected from social media entries provided by the inactive customers and (2) data about interactions that specify the inactive customers.

10. A computer program product, comprising:
a computer-readable storage medium; and
a computer-readable program code stored in the computer-readable storage medium, the computer-readable program code containing instructions that are executed by a central processing unit (CPU) of a computer system to implement a method of managing a contact with an inactive customer, the method comprising the steps of:
receiving, by the computer system, data specifying activity of a plurality of customers and based on the data specifying the activity of the plurality of customers, grouping the plurality of customers into active and inactive customers;
based on data specifying activity of the active customers, grouping, by the computer system, the active customers into defined activity segments, each activity segment describing a corresponding level of activity and style of activity of a corresponding group of the active customers;
based on textual data authored by the active customers in the activity segments, determining, by the computer system, personality traits, values, and needs of the active customers;
generating, by the computer system, a mapping between (1) the personality traits, values, and needs of the active customers and (2) the defined activity segments;
based on textual data authored by an inactive customer, determining, by the computer system, personality traits, values, and needs of the inactive customer;
based on the personality traits, values, and needs of the inactive customer, determining, by the computer system and using the generated mapping, an activity segment in which the inactive customer likely belongs;
selecting, by the computer system, one or more actions corresponding to the active customers in the determined activity segment in which the inactive customer likely belongs; and
applying, by the computer system, the selected one or more actions to the inactive customer, which increases a likelihood of the inactive customer becoming engaged in an activity similar to activities performed by the active customers.

11. The computer program product of claim 10, wherein the step of generating the mapping includes the steps of:
receiving, by the computer system, personality traits, values and needs data of a group of people, the received personality traits, values and needs data including a multitude of character features and a multitude of activity segments which are associated with the multitude of character features;
building, by the computer system, a model which learns associations between the multitude of character features and the multitude of activity segments; and
mapping, by the computer system and using the model, one or more of the multitude of character features to one or more of the multitude of activity segments.

12. The computer program product of claim 11, wherein the step of building the model includes the step of determining associations between the personality traits, values, and needs of the active customers and the defined activity segments by using a classification technique that employs decision trees or a parametric machine learning algorithm that employs regression.

13. The computer program product of claim 10, wherein the step of selecting the one or more actions corresponding to the active customers in the determined activity segment in which the inactive customer likely belongs includes the steps of:
selecting, by the computer system, a preferred contact method or channel by which the active customers are staying in contact with an enterprise, and which corresponds to the determined activity segment in which the inactive customer likely belongs; and
contacting the inactive customer using the selected contact method or channel, thereby increasing a likelihood that the inactive customer responds to the contact and becomes an active customer.

14. The computer program product of claim 10, wherein the step of selecting the one or more actions corresponding to the active customers in the determined activity segment in which the inactive customer likely belongs includes the steps of:
determining, by the computer system, products in which the active customers are likely to be interested, each product corresponding to one of the activity segments; and
recommending one of the products to the inactive customer so that the recommended product has a corresponding activity segment which matches the determined activity segment in which the inactive customer likely belongs, thereby increasing a likelihood that the inactive customer buys the recommended product and becomes an active customer.

15. The computer program product of claim 10, wherein the step of grouping the plurality of customers includes the steps of:
receiving a period of time which is based on a company policy;
determining transactional activities of the plurality of customers over the period of time;
identifying one group of customers included in the plurality of customers who each performed at least a predetermined number of the transactional activities during the period of time and identifying another group of customers included in the plurality of customers who each performed less than the predetermined number of the transactional activities during the period of time;
based on the identified one group of customers each performing at least the predetermined number of transactional activities during the period of time, categorizing the one group of customers as the active customers; and
based on the identified other group of customers each performing less than the predetermined number of transactional activities during the period of time, categorizing the other group of customers as the inactive customers.

16. A computer system comprising:
a central processing unit (CPU);
a memory coupled to the CPU; and
a computer readable storage device coupled to the CPU, the storage device containing instructions that are executed by the CPU via the memory to implement a method of managing a contact with an inactive customer, the method comprising the steps of:
receiving, by the computer system, data specifying activity of a plurality of customers and based on the data specifying the activity of the plurality of customers, grouping the plurality of customers into active and inactive customers;
based on data specifying activity of the active customers, grouping, by the computer system, the active customers into defined activity segments, each activity segment describing a corresponding level of activity and style of activity of a corresponding group of the active customers;
based on textual data authored by the active customers in the activity segments, determining, by the computer system, personality traits, values, and needs of the active customers;
generating, by the computer system, a mapping between (1) the personality traits, values, and needs of the active customers and (2) the defined activity segments;
based on textual data authored by an inactive customer, determining, by the computer system, personality traits, values, and needs of the inactive customer;
based on the personality traits, values, and needs of the inactive customer, determining, by the computer system and using the generated mapping, an activity segment in which the inactive customer likely belongs;
selecting, by the computer system, one or more actions corresponding to the active customers in the determined activity segment in which the inactive customer likely belongs; and
applying, by the computer system, the selected one or more actions to the inactive customer, which increases a likelihood of the inactive customer becoming engaged in an activity similar to activities performed by the active customers.

17. The computer system of claim 16, wherein the step of generating the mapping includes the steps of:
receiving, by the computer system, personality traits, values and needs data of a group of people, the received personality traits, values and needs data including a multitude of character features and a multitude of activity segments which are associated with the multitude of character features;
building, by the computer system, a model which learns associations between the multitude of character features and the multitude of activity segments; and
mapping, by the computer system and using the model, one or more of the multitude of character features to one or more of the multitude of activity segments.

18. The computer system of claim 17, wherein the step of building the model includes the step of determining associations between the personality traits, values, and needs of the active customers and the defined activity segments by using a classification technique that employs decision trees or a parametric machine learning algorithm that employs regression.

19. The computer system of claim 16, wherein the step of selecting the one or more actions corresponding to the active customers in the determined activity segment in which the inactive customer likely belongs includes the steps of:
selecting, by the computer system, a preferred contact method or channel by which the active customers are staying in contact with an enterprise, and which corresponds to the determined activity segment in which the inactive customer likely belongs; and
contacting the inactive customer using the selected contact method or channel, thereby increasing a likelihood that the inactive customer responds to the contact and becomes an active customer.

20. The computer system of claim 16, wherein the step of selecting the one or more actions corresponding to the active customers in the determined activity segment in which the inactive customer likely belongs includes the steps of:
determining, by the computer system, products in which the active customers are likely to be interested, each product corresponding to one of the activity segments; and
recommending one of the products to the inactive customer so that the recommended product has a corresponding activity segment which matches the determined activity segment in which the inactive customer likely belongs, thereby increasing a likelihood that the inactive customer buys the recommended product and becomes an active customer.
